(19) United States
(12) Patent Application Publication
(10) Pub. No.: US 2006/0007967 A1
(43) Pub. Date: Jan. 12, 2006

(54) Method for selecting laser output wavelength

(76) Inventor: John E. Nettleton, Fairfax Station, VA (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/885,802

(22) Filed: Jul. 8, 2004

(51) Int. Cl. H01S 3/10

(52) U.S. Cl. 372/20; 372/21; 372/106

(57) ABSTRACT

The device of the present invention includes a laser source which produces a laser output, an optical parametric oscillator optically connected in series to a laser source wherein the optical parametric oscillator has a predetermined polarization that can be changed and the polarization of the optical parametric oscillator can be changed such that the laser output is altered to a predetermined wavelength. The laser designator and range finder according to the invention is centered on the use of an OPO crystal in the lasing process of the laser designator. The laser designator and range finder is based on the concept that the laser pulse is highly polarized and can be efficiently converted to the eye safe 1.5 microns wavelength by changing the polarization of the laser output so that an eye safe laser output is generated. This is done either via inserting a half wave plate and rotating it without moving the OPO crystal or via inserting an Electro-Optical crystal that is capable of generating a half wave with the appropriate voltage applied.

### GOVERNMENT INTEREST

The invention described herein may be manufactured, used, sold, imported, and/or licensed by or for the Government of the United States of America.

### FIELD OF INTEREST

This invention relates to solid state pulsed laser devices such as military laser designators.

### BACKGROUND OF THE INVENTION

Current fielded military laser designators are required to perform eye safe range finding and be capable of eye safe designation for training. A separate eye safe laser range finder is added to the already overweight and bulky laser designator system to perform the range finding function. The eye safe designation for training is more difficult to perform with today's systems. This function is currently performed by attenuating the output of the designator to an energy level less hazardous, but hardly eye safe. Unfortunately, this method is limited by the weather and field obscuration conditions which lead to the unrealistic training scenarios.

### SUMMARY OF THE INVENTION

Accordingly, one object of the present invention is to provide an eye safe range finder while minimizing the weight and size of the system.

This and other objects of the present invention are achieved by using a new method for selecting the laser's output wavelength. The present invention can easily switch between the 1 micron non-eye safe output for designation and the 1.5 micron eye safe laser output for range finding and training.

The device of the present invention includes a laser source which produces a laser output, an optical parametric oscillator optically connected in series to a laser source wherein the optical parametric oscillator has a predetermined polarization that can be changed and the polarization of the optical parametric oscillator can be changed such that the laser output is altered to a predetermined wavelength.

The laser designator and range finder of the present invention is based on the concept that the laser output pulse is highly polarized and can be efficiently converted to the eye safe 1.5 microns wavelength by changing the polarization of the laser output so that an eye safe laser output is generated. This is done either via inserting a half wave plate and rotating it without moving the OPO crystal or via inserting an Electro-Optical crystal that is capable of generating a half wave with the appropriate voltage applied.

### BRIEF DESCRIPTION OF THE DRAWINGS

These and other objects of the invention will become readily apparent in light of the Detailed Description Of The Invention and the attached drawings wherein:

FIG. 1 is a block diagram of the present invention wherein a typical single pass OPO external cavity is shown.

FIG. 2 is a block diagram of the present invention wherein polarization is achieved via rotating the OPO cavity and inserting a filter.

FIG. 3 is a block diagram of the present invention wherein polarization is achieved via rotation of a half wave plate and inserting a filter.

FIG. 4 is a block diagram of the present invention wherein polarization is achieved via rotation of an Electro-Optical (E-O) crystal and inserting a filter.

### DETAILED DESCRIPTION OF THE INVENTION

The present invention is a new method for selecting laser output wavelength. The present invention can easily switch between the 1 micron non-eye safe output for designation and the 1.5 micron eye safe laser output for range finding and training.

The proposed concept of the present invention is based on the conversion of the 1 micro to 1.5 microns through the optical parametric oscillation (OPO) process. The OPO process required highly polarized laser input, which is precisely what a laser designator generates. This concept takes into consideration the difficultly of inserting an OPO crystal into the laser path of the laser designator. Moving the OPO crystal in and out using mechanical means is uncertain at best. The OPO is a resonating cavity and its alignment to the optical path of the designator's laser beam is critical for efficient wavelength conversion and acceptable beam quality.

More importantly, this concept can be a retrofit to the military's existing laser designation devices in the inventory that would improve on their operational and training capabilities.

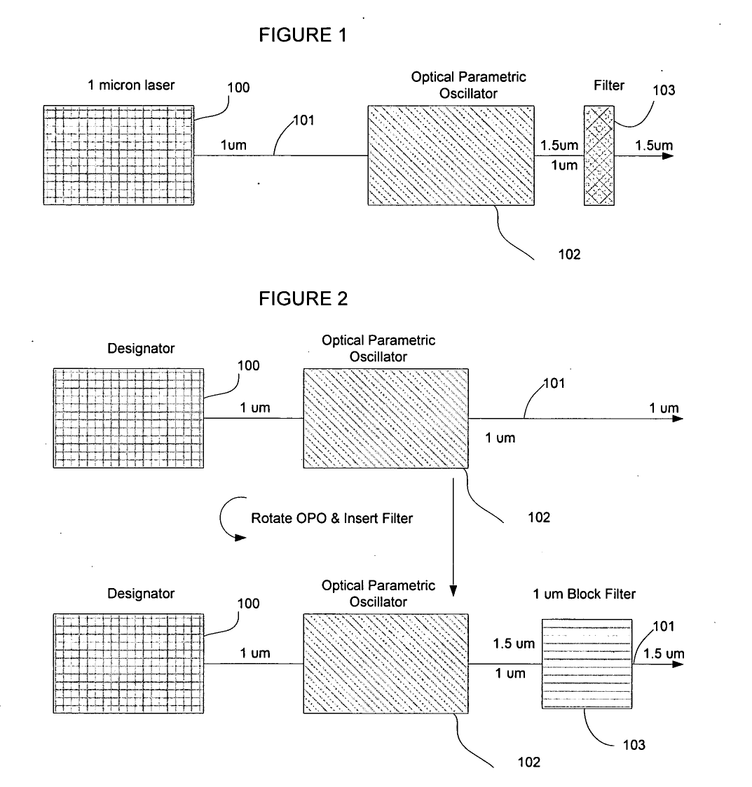

The proposed invention is centered on the use of an OPO crystal in the lasing process of the laser designator. The invention is based on the concept that the laser pulse is highly polarized and can be efficiently converted to the eye safe 1.5 microns wavelength as shown in FIG. 1. As shown in FIG. 1, a pump laser source 100 generates a laser signal, as represented by arrowed line 101, of nominally 1 micron. The laser signal is fed through an OPO cavity 102 to alter the laser signal's wavelength to a greater wavelength, nominally 1.5.

The OPO process is 30% to 40% efficient. The unconverted portion of the 1 micron pump laser 100 must be blocked using a filter 103 (FIG. 1) so that the output will be all at 1.5 microns. But now, the output needs to be switched between the 1 micron and 1.5 microns for the designator (also designated 100) and range finder functions, respectively. The simplest approach is to remove the OPO crystal and the 1 micron blocking filter 103 to get the 1 micron output 101 and then insert them back in to the optical path to get the 1.5 micron output 101. Unfortunately, inserting the OPO 102 in and out of the optical path is not trivial. The OPO 102 crystal 101 itself is a resonant cavity. Slight misalignments can severely impact the conversion efficiency from 1 micron to 1.5 micron and spoil the 1.5 micron beam quality. The filter's 103 alignment is not critical so it can be easily inserted into and out of the optical path.

The present invention selects wavelengths from the OPO based system by changing the polarization of the laser output 100. Since the OPO process is highly dependent on the polarization of the laser pump, the present invention uses this relationship to select what wavelength is transmitted. FIG. 2 is illustrates a very simple case in which the OPO crystal 102 itself is rotated into and out of the correct polarization for conversion and a block filter 103 is inserted. Rotation of the OPO crystal 102 is less troublesome than complete removal. But still, this involves moving a resonant cavity where the alignment critical. Therefore, this is not a very practical way to make the range finder eye safe, but it will work.

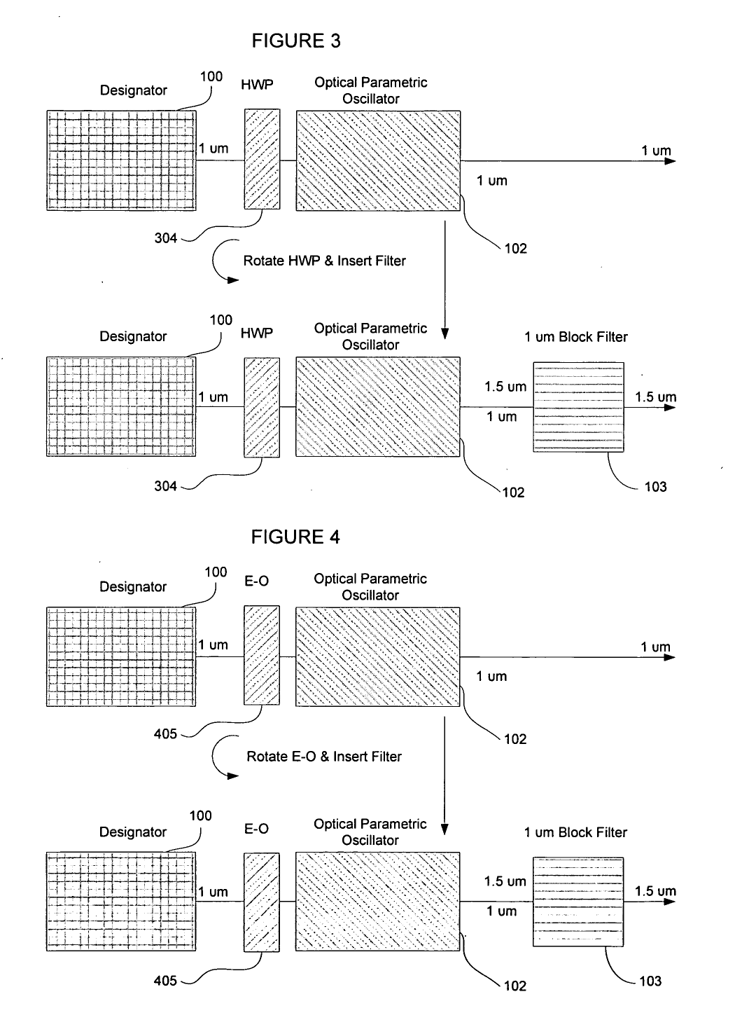

FIG. 3 depicts a more practical method to achieve the goals of the present invention wherein a half-wave plate (HWP) 304 is inserted into the cavity. Rotating the HWP 304 rotates the polarization of the laser beam 101, thus, the OPO crystal 102 can remain stationary.

FIG. 4 depicts another practical and preferred method to remove the need for mechanical motion. It replaces the HWP with an Electro-Optical (E-O) crystal 405 that is capable of generating the half wave for the 1 micron laser signal 101 with the appropriate voltage applied. Note that the voltage is applied for only a very short time when the laser designator is fired.

Notice that the 1 micron blocking filter 103 is inserted for the above described methods. This filter 103 is necessary to block the unconverted and undesired 1 micron laser and permits only a 1.5 micron wavelength output to emerge. This filter 103 is not alignment critical and can easily be placed on a mechanical slide or a simple screw-on window.

The present invention benefits military laser designators that are required to perform eye safe range finding and be capable of eye safe designation for training. This present invention allows for the laser designator to select the laser output wavelength. The new method of the present invention can easily switch between the 1 micron non-eye safe laser output for designation and the 1.5 micron eye safe laser output for range finding and training. The proposed method does not require movement of the OPO crystal, which can cause misalignment.

What is claimed is:

1. A device for selecting laser output wavelength comprising:
a laser source which produces a laser output;
optical parametric oscillator optically connected to the laser source in series wherein the optical parametric oscillator has a predetermined polarization that can be changed; and
means to change the polarization of the optical parametric oscillator such that the laser output is altered to a predetermined wavelength.

2. The device for selecting laser output wavelength of claim 1 wherein the laser source is a designator and further comprises a block filter.

3. The device for selecting laser output wavelength of claim 1 wherein the means to change the polarization of the optical parametric oscillator comprises a means to rotate the optical parametric oscillator and to insert a filter in series after the optical parametric oscillator.

4. The device for selecting laser output wavelength of claim 1 wherein the means to change the polarization of the optical parametric oscillator comprises a rotatable half-wave plate to alter the polarization of the laser output and means to insert a filter in series after the optical parametric oscillator, wherein the half-wave plate is connected in series between the laser source and the optical parametric oscillator.

5. The device for selecting laser output wavelength of claim 1 wherein the means to change the polarization of the optical parametric oscillator comprises an electro-optic crystal to alter the polarization of the laser output and means to insert a filter in series after the optical parametric oscillator, wherein the electro-optic crystal is connected in series between the laser source and the optical parametric oscillator.

6. The device for selecting laser output wavelength of claim 5 wherein a voltage is applied to the electro-optic crystal to alter the polarization of the laser output.

7. The device for selecting laser output wavelength of claim 1 wherein the laser output from the laser source is non-eye safe and is converted to an eye safe output.

8. The device for selecting laser output wavelength of claim 7 wherein the laser output is 1 υm and is converted to a 1.5 υm output.

9. A method for selecting laser output wavelength comprising:
providing a laser source which produces a laser output;
providing optical parametric oscillator optically connected to the laser source in series wherein the optical parametric oscillator has a predetermined polarization that can be changed; and
changing the polarization of the optical parametric oscillator such that the laser output is altered to a predetermined wavelength.

10. The method for selecting laser output wavelength of claim 9 wherein the laser source is a designator and further comprises a block filter.

11. The method for selecting laser output wavelength of claim 9 wherein changing the polarization of the optical parametric oscillator comprises the steps of rotating the optical parametric oscillator and inserting a filter in series after the optical parametric oscillator.

12. The method for selecting laser output wavelength of claim 9 wherein changing the polarization of the optical parametric oscillator comprises the steps of connecting a half-wave plate in series between the laser source and the optical parametric oscillator, rotating a half-wave plate to alter the polarization of the laser output, and inserting a filter in series after the optical parametric oscillator.

13. The method for selecting laser output wavelength of claim 9 wherein changing the polarization of the optical parametric oscillator comprises the steps of connecting an electro-optic crystal in series between the laser source and the optical parametric oscillator to alter the polarization of the laser output and inserting a filter in series after the optical parametric oscillator.

14. The method for selecting laser output wavelength of claim 13 further comprising the step of applying a voltage is applied to the electro-optic crystal to alter the polarization of the laser output.

15. The method for selecting laser output wavelength of claim 9 wherein the laser output from the laser source is non-eye safe and is converted to an eye safe output.

16. The method for selecting laser output wavelength of claim 15 wherein the laser output is 1 υm and is converted to a 1.5 υm output.
